(19) United States
(12) Patent Application Publication
(10) Pub. No.: US 2008/0189004 A1
(43) Pub. Date: Aug. 7, 2008

(54) Ball collection apparatus

(76) Inventors: Richard McMurtry, Redland (GB); Ben McMurtry, Horsley (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/011,461

(22) Filed: Jan. 25, 2008

(30) Foreign Application Priority Data
Jan. 26, 2007 (GB) 0701564.7

(51) Int. Cl. G05D 3/00; A63B 47/02; A63B 57/00

(52) U.S. Cl. 701/25; 701/2; 414/467; 701/213

(57) ABSTRACT

A method is provided for operating an autonomous ball collection vehicle over a work area. Initially, information relating to the distribution of balls in the work area is determined. Then, the vehicle is guided around the work area to collect balls in response to the determined information.

### BACKGROUND OF THE INVENTION

This invention relates to a ball collection apparatus, and in particular relates to a method and apparatus for operating an autonomous ball collection vehicle for a golf driving range or similar in an efficient manner.

Conventionally, the collection of golf balls at a driving range is carried out using a manually operated machine. The machine may be a ride-on tractor unit, small utility vehicle or similar with a collector attachment, or a walk-behind collector. The collector picks the balls from the ground and deposits them in baskets or ball receptacles on the machine. Once the baskets are full, the machine is taken to an unloading point where the baskets are emptied, usually by the operator physically removing the baskets from the machine.

The area covered by such machines depends on the size of the driving range, but is usually in the region of 2 to 12 acres. Similar machines can be used in connection with other sports, such as machines for collecting baseballs on a practice baseball pitch or tennis balls on a tennis court.

Vehicles or machines are known which eliminate the need for the operator to manually empty the baskets or ball containers at the unloading point. U.S. Pat. No. 5,332,350 describes a golf ball handling system in which the golf ball receptacle is emptied by opening a set of moveable doors in the base of the receptacle and allowing the golf balls to fall through, or by tilting the receptacle to a dump position in which the golf balls fall out of the receptacle.

Golf ball collection vehicles that operate over the driving range autonomously (i.e. without requiring an operator to be present on the vehicle) are known. One such vehicle is described in US 2005/204717. This vehicle generally operates randomly or pseudo-randomly over the ball pick-up surface (in the sense that the path it follows over the surface is random or pseudo-random). Alternatively, if it is desirable to clear the entire pick-up surface, for example to allow the grass to be mown, the vehicle may follow a systematic path (i.e. up and down the surface in parallel bands). However, if there is an urgent need for golf balls to be collected quickly, i.e. if the driving range is busy and the golf ball dispenser is empty or nearly empty, the random or pseudo-random operation of this vehicle may result in the vehicle spending significant time in areas of the driving range that are not heavily populated by golf balls. Thus, during busy times, the vehicle may be unable to collect enough golf balls quickly to satisfy the demand of users of the driving range.

There is therefore a need for an autonomous ball collection vehicle that can operate efficiently over a ball collection area, which allows it to handle a high demand for balls.

### SUMMARY OF THE INVENTION

In accordance with a first aspect of the invention, there is provided a method of operating an autonomous ball collection vehicle over a work area comprising determining information relating to the distribution of balls in the work area; and guiding the vehicle around the work area to collect balls in response to the determined information.

In accordance with a second aspect of the invention, there is provided an apparatus comprising a memory for storing information relating to the distribution of balls in a work area; and processing means for guiding a vehicle around the work area to collect balls in response to the information stored in the memory.

A third aspect of the invention relates to a computer program for performing the method as described above.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a vehicle in accordance with the invention.

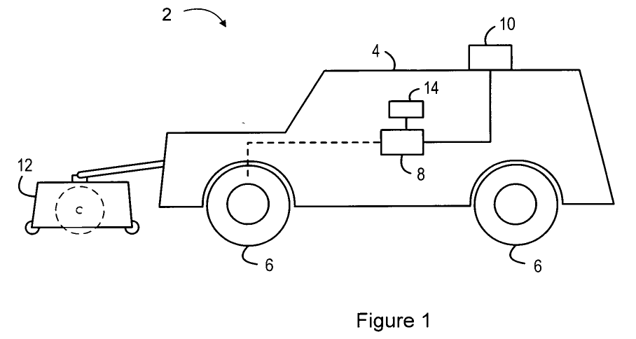

FIG. 2 is a plan view of a driving range in which a vehicle in accordance with the invention can operate.

FIG. 3 is a plan view of the driving range illustrating a possible distribution of golf balls.

FIG. 4 is a flow chart illustrating the steps in a method of operating an autonomous vehicle in accordance with the invention.

### DETAILED DESCRIPTION OF THE PREFERRED EMBODIMENT

The invention will now be described with reference to an autonomous ball collection vehicle for use in collecting golf balls on a driving range, although it will be appreciated that the invention can be applied to autonomous vehicles for use in collecting tennis balls, baseballs, or other types of ball in the appropriate practice or playing areas.

The vehicle 2 comprises a body 4 and at least one wheel 6. The at least one wheel 6 may be adapted for steering and/or driving the vehicle around the work area in response to control signals received from a controller 8 that is located on the vehicle 2. In the illustrated embodiment, the vehicle 2 comprises two sets of wheels 6. Alternatively, the vehicle 2 may be provided with one or more tracks rather than wheels.

A position sensor unit 10 is provided on or in the vehicle 2 for sensing the position of the vehicle 2 in the work area in conjunction with the controller 8. The position sensor unit 10 may use any suitable position sensing technology to sense its position in the work area, including, but not limited to, GPS, differential GPS, real-time kinematic GPS, transponders (buried beneath the surface of the work area or otherwise), wire guides, laser reflectors or radio beacons. Depending on the type of position/location technology used, the position sensor unit 10 may determine the position of the vehicle 2 in the work area and pass this to the controller 8, or it may take measurements and pass these to the controller 8 for the controller 8 to determine the position of the vehicle 2 in the work area.

The vehicle 2 further comprises a ball collector 12. The ball collector 12 may be integral to the vehicle 2 or may be a distinct unit that can be separated from the vehicle if required. The ball collector 12 may comprise any suitable mechanism for picking up balls from the surface of the work area, such as a set of rotating discs, and may comprise a container or basket for storing the balls that are picked up by the discs.

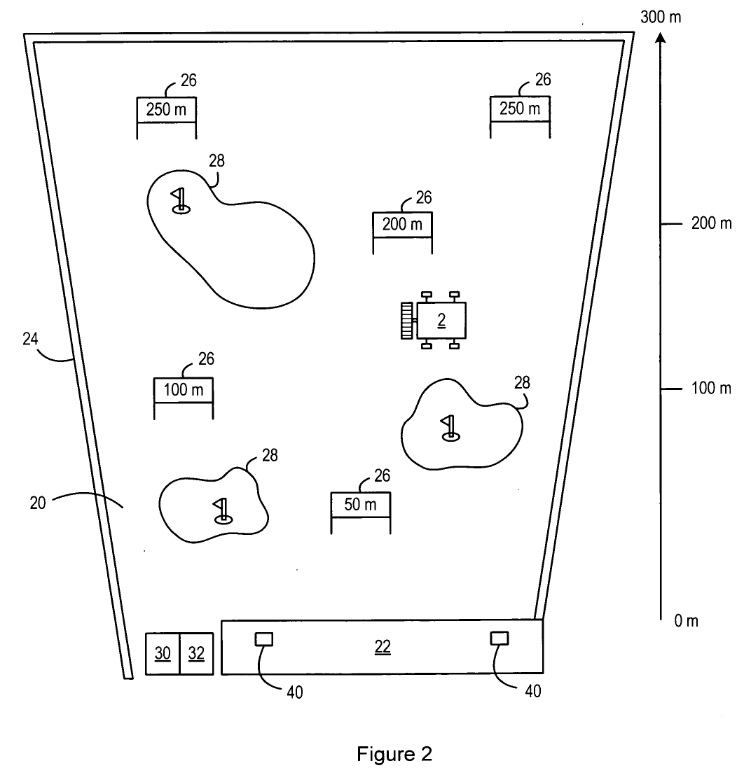

FIG. 2 shows a typical arrangement of a driving range 20 in which an autonomous ball collection vehicle 2 can operate in accordance with the invention. The driving range 20, which corresponds to the work area for the vehicle 2, comprises a number of driving bays 22, a boundary fence 24, and a variety of features, such as distance markers 26 and target greens 28. As shown by the distance indicator, the driving range 20 is approximately 300 meters long, which allows users of the driving range to hit a full range of shots whilst allowing the golf balls to remain within the confines of the driving range 20.

Depending on the position sensing technology used by the position sensor 10 on the vehicle 2, the driving range 20 may comprise the appropriate elements required for the position sensor 10 to operate. For example, the driving range 20 may have transponders buried beneath the surface of the driving range 20 or laser reflectors may be positioned around or within the boundary of the driving range 20.

The driving range 20 also comprises an unloading station 30 for the vehicle 2. When the vehicle 2 has completed its operation, or when the containers or baskets in the ball collector 12 are full, the vehicle 2 returns to the unloading station 30 where the containers or baskets are emptied, either manually by a member of staff, or, preferably, automatically by the vehicle 2.

In this embodiment, the unloading station 30 is coupled to a golf ball dispensing unit 32 which receives the golf balls unloaded at the unload station 30 and which dispenses a quantity of golf balls to users of the driving range 20. The unloading station 30 and dispensing unit 32 may be integrally formed with each other, or they may be separate units. In alternative embodiments, the unloading station 30 may not be coupled to a dispensing unit 32.

The vehicle 2 may operate continuously or periodically when the driving range 20 is open for use, in order to ensure that a sufficient number of golf balls are available at the ball dispensing unit 32. Alternatively, the vehicle 2 may only operate when the ball dispensing unit 32 indicates that the number of balls available for dispensing have fallen below a predetermined threshold, or when the ball dispensing unit 32 is empty. Alternatively, the vehicle 2 may operate when the range 20 is closed, and/or at night. In any case, it is desirable for the vehicle 2 to collect as many golf balls as possible in the shortest possible time.

Users of the driving range 20 will hit golf balls from the driving bays 22 using a variety of different clubs, which result in the golf balls being hit a number of different distances down the range 20. In addition, it is often the case that a user of the range 20 will hit golf balls towards a particular feature, such as distance markers 26 or target greens 28, in order to improve their accuracy. Therefore, it is common for a significant number of golf balls hit by users of the driving range 20 to accumulate around the features 26, 28.

Furthermore, even if users of the range 20 do not aim at a particular feature 26, 28, it is common for them to aim towards the middle of the range 20, rather than near to the boundary fences 24.

Also, many users of the driving range 20 will only be able to hit a golf ball a limited distance in comparison to the full length (300 meters in this case) of the driving range 20. Therefore, it is common for there to be very few golf balls towards the end of the driving range 20 in comparison to the first 150 meters from the driving bays 22.

In addition, the distribution of golf balls may have a temporal element, particularly if the driving range 20 is set aside for use by a particular group of people at a certain time. For example, the driving range 20 may have a designated beginner session. In this case, it is unlikely that those users of the driving range 20 will be able to hit the balls a great distance from the driving bays 22, so the density of golf balls near to the driving bays (such as within the first 100 meters) will be much higher than further down the range 20. Alternatively, there may be a designated session for advanced players, which means that the concentration of golf balls around the features 26, 28 of the range 20 may be higher than usual.

Therefore, the distribution of golf balls across a driving range 20 will be uneven, and there may be a number of parts of the range 20 in which the density or concentration of golf balls is considerably higher than in other parts.

Thus, in order to improve the efficiency of an autonomous ball collection vehicle, it is desirable for the vehicle to concentrate on, or at least give priority to, parts of the range 20 in which the distribution of golf balls is known or expected to be higher.

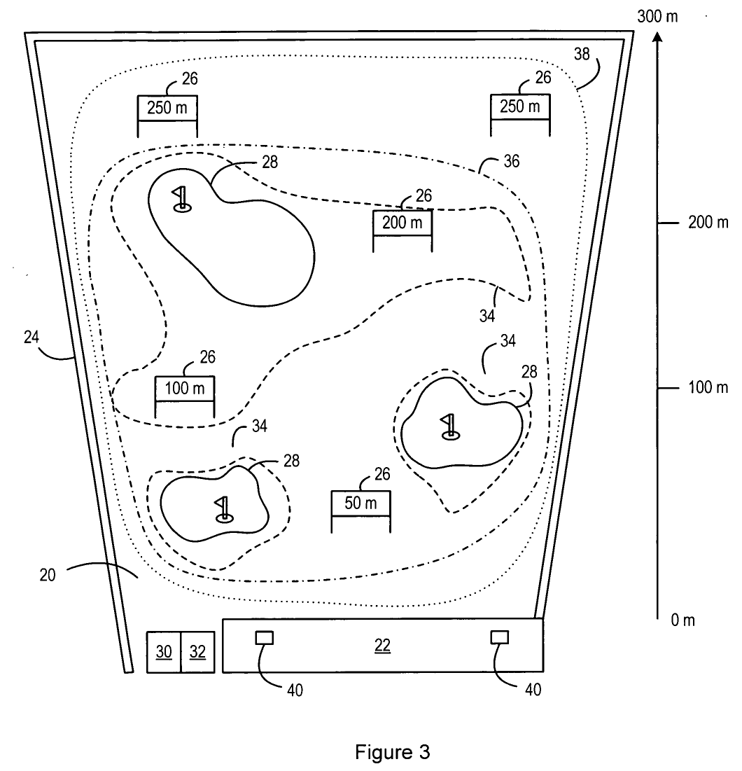

Therefore, in accordance with the invention, the autonomous ball collection vehicle 2 is adapted to operate over the range 20 in response to the known or expected distribution of balls. In a particular embodiment, the vehicle 2 is provided with a memory 14 or other suitable storage means for storing information relating to the known or expected distribution of balls in the driving range 20. In some embodiments, this information can comprise a density pattern that represents the relative distribution of balls throughout the range. A graphical illustration of a density pattern is shown in FIG. 3. Of course, it will be appreciated that the information represented by this pattern can be stored in the memory in any suitable form. The controller 8 is adapted to use this stored information to guide the vehicle 2 around the driving range 20.

Preferably, the information relating to the distribution of balls in the range is determined and stored prior to the vehicle commencing its collection operation.

Preferably, the information in the memory 14 comprises spatial coordinates based on the technology used by the position sensing unit 10 (e.g. GPS coordinates, distance from each laser scanner, etc). If the distribution changes with the time of day and/or day of the week, appropriate alternative distributions can be provided.

In one embodiment, the controller 8 computes a work regime for the vehicle 2 to follow based on the information stored in the memory 14 before the vehicle 2 starts its collection operation. This work regime may define the number, length and direction of strokes to be made by the vehicle 2 and/or the direction and magnitude of turns. Once this work regime is computed, the controller 8 controls the vehicle 2 to perform the work regime, in order for golf balls to be collected in the areas covered by the vehicle 2. Alternatively, the work regime may not define a complete work operation of the vehicle 2, but may relate to the operation of the vehicle 2 over a certain period of time or distance traveled, after which a new work regime needs to be determined.

If the baskets or containers in the ball collector 12 get filled with golf balls before the work regime is completed, the controller 8 may guide the vehicle 2 to the unloading station 30 so that the baskets or containers can be emptied, and the controller 8 can then guide the vehicle 2 to resume the work regime.

Preferably, the computed work regime will result in the vehicle 2 initially covering the parts of the range 20 in which the golf ball density is, or is likely to be, highest, and then moving to parts of the range 20 where golf ball density is, or is likely to be, lower. Alternatively, the computed work regime may result in the vehicle 2 allocating more operational time to parts of the range 20 in which the golf ball density is, or is likely to be, higher, and less operational time to parts of the range 20 in which the density is, or is likely to be, lower.

The controller 8 may determine the work regime as described in International patent application no. PCT/GB03/00351.

In an alternative embodiment, the work regime may be determined by a processor (such as a laptop, real-time computer or similar) that is separate to the vehicle 2, and then uploaded to the memory 14 of the vehicle 2 when necessary. In this case, the invention will be embodied in both the remote processor and the vehicle 2.

In a further alternative embodiment, the work regime may be determined by a processor (such as a laptop, real-time computer or similar) that is separate to the vehicle 2, and the appropriate instructions for executing the regime can be transmitted to the controller 8 in the vehicle 2. In this case, the vehicle 2 will need to be provided with some means for continuously or periodically receiving instructions from the processor, that are then passed to the controller 8 for execution. These instructions may comprise simple real-time commands such as forward, backward, turn left, turn right, or specified commands such as forward by a certain distance, backward by a certain distance, turn by a particular angle, or with a particular turning radius. In this case, the inventive apparatus will be separate to the vehicle 2.

The controller 8 may also be adapted to modify its operation in accordance with the prevailing weather and ground conditions as described in International patent application no. PCT/GB03/00359.

In an alternative embodiment, the vehicle 2 may operate without computing a work regime beforehand. In this case, the controller 8 can determine the operation of the vehicle 2 on the fly from the information stored in the memory 14. Again, in an alternative embodiment, a processor (such as a laptop, real-time computer or similar) that is remote from the vehicle 2 can determine the operation of the vehicle 2 from the information relating to the distribution of balls in the work area, and transmit commands to the vehicle 2 for the controller 8 to execute.

FIG. 3 shows the driving range of FIG. 2 with a possible golf ball distribution pattern. The parts of the range 20 delimited by dotted lines 34 indicate parts that have, or are likely to have, a high concentration or distribution of golf balls in comparison to other parts of the driving range 20. The parts of the range 20 delimited by dotted lines 36 indicate parts that have, or are likely to have, a reasonable concentration or distribution of golf balls in comparison to other parts of the driving range 20. The parts of the range 20 delimited by dotted lines 38 indicate parts that have, or are likely to have, a lower concentration or distribution of golf balls in comparison to other parts of the driving range 20. The part of the range 20 outside the dotted line 38 is a part of the range 20 with a very low concentration or distribution of golf balls.

Thus, in accordance with the invention, the vehicle 2 will concentrate its operation on the parts indicated by line 34. Once these parts have been covered, the vehicle 2 can move on to the other parts of the driving range 20. As described above, concentrating its operation on these parts 34 may comprise the vehicle 2 covering these parts at the start of its work operation, or it may comprise the vehicle 2 spending a disproportionate amount of time in these parts 34 than in other parts.

It will be appreciated that although the driving range 20 in FIG. 3 is divided into parts with one of four different levels of ball concentration or distribution, it is possible to use more or less than four levels.

As the condition of the surface of the driving range 20 may vary according to the weather or condition of the ground, further information may be provided to the vehicle 2 that indicates a part or parts of the driving range 20 that should be avoided during a work operation.

The information relating to the likely or expected distribution of golf balls on the range 20 may be determined by observing the patterns of golf balls on the range 20 over a period of time.

Alternatively, the vehicle 2 may determine the information relating to the expected distribution of golf balls based on previous collection operations. The vehicle 2 or ball collector 12 may comprise a sensor for monitoring the quantity of balls collected in a given area (as determined by the position sensor 10).

In one embodiment, the information about the distribution of golf balls on the range 20 is known. In this case, an operator of the range 20 can input the information relating to the distribution of golf balls on the range 20 into the memory 14 of the vehicle 2 before it starts operating. However, in a preferred embodiment, the information about the known distribution of golf balls on the range 20 is provided to the memory 14 of the vehicle 2 by a visual sensor or sensors 40 which observe the state of the driving range 20. In the illustrated embodiment, the visual sensors 40, which can be video or still cameras or any other suitable device, are positioned on the driving bays 22 overlooking the driving range surface. Alternatively, the visual sensor or sensors 40 can be located or mounted on the vehicle 2.

A processor is provided for processing an image or images from the sensors 40 in order to determine which parts of the driving range 20 currently have a high or low distribution of golf balls. This processor can be located in the vehicle 2, possibly as part of the controller 8, in which case the sensors 40 have some means (either wired or wireless) for providing the images to the processor, or the processor can be located proximate to the sensors 40, in which case the processor has some means (again either wired or wireless) for providing the determined information to the memory 14 of the vehicle 2.

In either case, current information about the distribution of golf balls on the range can be supplemented by information about the likely distribution of golf balls stored in the memory 14.

In addition to operating the vehicle 2 as described above, the controller 8 may also be able to operate the vehicle 2 to systematically cover the whole of the driving range 2. This may be to clear the range 20 of balls so that the grass may be mown without the risk of golf balls on the range 20 damaging the cutting blades. A work regime for this mode of operation can be stored in the memory 14.

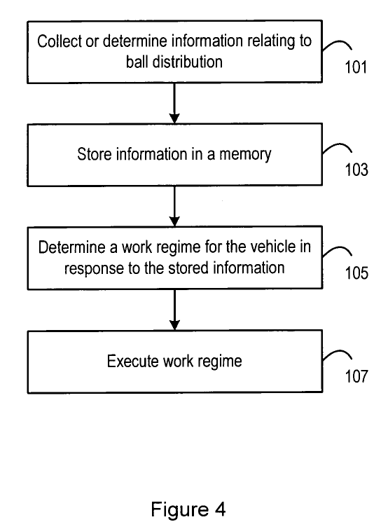

FIG. 4 shows a method of operating an autonomous vehicle 2 in accordance with the invention. In step 101, the information relating to the distribution of balls in the work area is determined or collected. As described above, this information can be determined on the basis of known usage patterns of the driving range 20, from previous collection operations by the vehicle 2, from one or more visual sensors 40 at the range 20 or from information input by an operator. This information can then be stored in a memory, either in the vehicle 2, or elsewhere (step 103).

The information is then used to determine a work regime for the vehicle 2 (step 105) in order to collect balls in the most efficient manner. As described above, the work regime can be computed by the controller 8 in the vehicle 2, or computed remote from the vehicle 2 and uploaded to the memory 14. In step 107, the computed work regime is executed by the vehicle 2.

It will be appreciated that the functionality provided by the present invention can be retrofitted to an existing autonomous ball collection vehicle by replacing or adding a controller 8 and memory 14 as described above.

Thus, there is therefore provided an apparatus that provides for the efficient collection of balls in a work area.

As described above, the invention may be implemented entirely in an autonomous vehicle, or aspects of the invention may be split between the vehicle and a remote device, or the inventive aspects may be implemented entirely in a device remote from the vehicle. As a result, the term “apparatus” in the claims is intended to cover a vehicle, a remote device or processor such as a laptop or real-time computer, and/or both a vehicle and a remote device.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A method of operating an autonomous ball collection vehicle over a work area comprising the steps of:
determining information relating to the distribution of balls in the work area; and
guiding the vehicle around the work area to collect balls in response to the determined information.

2. A method as claimed in claim 1, wherein the information comprises a density pattern representing the distribution of balls throughout the work area.

3. A method as claimed in claim 1, wherein the information relating to the distribution of balls is determined prior to commencing operation of the vehicle.

4. A method as claimed in claim 1, wherein the step of guiding comprises guiding the vehicle such that it starts its operation in parts of the work area in which the distribution of balls is high.

5. A method as claimed in claim 1, wherein the step of guiding comprises guiding the vehicle such that it operates primarily in parts of the work area in which the distribution of balls is high.

6. A method as claimed in claim 1, wherein the step of guiding comprises guiding the vehicle such that it operates in parts of the work area in which the distribution of balls is high more often than it operates in parts of the work area in which the distribution of balls is low.

7. A method as claimed in claim 1, further comprising sensing the position of the vehicle in the work area during the step of guiding.

8. A method as claimed in claim 7, wherein the step of sensing comprises sensing the position of the vehicle using one of GPS, differential GPS, real-time kinematic GPS, buried transponders, laser scanners, wire guides or radio beacons.

9. A method as claimed in claim 1, wherein the information relates to a known distribution of balls in the work area.

10. A method as claimed in claim 1, wherein the information relates to an expected distribution of balls in the work area.

11. A method as claimed in claim 10, wherein the information was collected by the vehicle during previous collection operations.

12. A method as claimed in claim 1, further comprising the step of storing the information in a memory of the vehicle.

13. A method as claimed in claim 12, wherein the step of guiding comprises determining a work regime from the stored information, and guiding the vehicle in response to the determined work regime.

14. A method as claimed in claim 1, further comprising the step of storing the information in a memory that is remote from the vehicle.

15. A method as claimed in claim 14, wherein the step of guiding comprises determining a work regime from the stored information by a processor that is remote from the vehicle.

16. A method as claimed in claim 15, wherein the step of guiding further comprises transmitting the determined work regime to the vehicle for execution.

17. A method as claimed in claim 15, wherein the step of guiding further comprises executing the determined work regime by the remote processor and transmitting movement commands to the vehicle.

18. A method as claimed in claim 12, wherein the information is stored in the memory by an operator.

19. A method as claimed in claim 12, wherein the information is provided to the memory by a visual sensor.

20. A method as claimed in claim 19 wherein the visual sensor is located on the vehicle.

21. A method as claimed in claim 19 wherein the visual sensor is remote from the vehicle.

22. A computer program comprising computer code that, when executed on one or more computers, causes the computer or computers to perform the method of claim 1.

23. An apparatus comprising:
a memory for storing information relating to the distribution of balls in a work area; and
processing means for guiding a vehicle around the work area to collect balls in response to the information stored in the memory.
